(19) United States
(12) Patent Application Publication
(10) Pub. No.: US 2022/0210264 A1
(43) Pub. Date: Jun. 30, 2022

(54) METHOD AND APPARATUS FOR EXECUTING APPLICATION

(71) Applicant: Samsung Electronics Co., Ltd., Gyeonggi-do (KR)

(72) Inventors: Kwanjin JUNG, Gyeonggi-do (KR); Hyunchul SEOK, Gyeonggi-do (KR); Daehyun CHO, Gyeonggi-do (KR); Wonseo CHOI, Gyeonggi-do (KR); Jinshik BAE, Gyeonggi-do (KR); Hongcheol SIM, Gyeonggi-do (KR)

(21) Appl. No.: 17/699,353

(22) Filed: Mar. 21, 2022

Related U.S. Application Data
(63) Continuation of application No. PCT/KR2020/012885, filed on Sep. 23, 2020.

(30) Foreign Application Priority Data
Sep. 27, 2019 (KR) 10-2019-0119831

(51) Int. Cl. H04M 1/72472; H04M 1/72403

(52) U.S. Cl. CPC H04M 1/72472; H04M 1/72403

(57) ABSTRACT

An electronic device and method are disclosed. The electronic device includes a display, a wireless communication unit, a memory and processor. The processor implements the method, including: identifying at least one application for which execution is predicted, based on a usage history of the electronic device and a state of the electronic device, executing a first loading procedure for the identified at least one application based on detecting satisfaction of a trigger condition related to the identified at least one application, after executing the first loading procedure, detecting occurrence of an event related to the identified at least one application, executing a second loading procedure for the identified at least one application in response to detecting the occurrence of the event, and on completion of the second loading procedure, displaying an execution screen of the identified at least one application via the display.

### CROSS-REFERENCE TO RELATED APPLICATION(S)

This application is a Continuation of and claims priority under 35 U.S.C. § 120 to PCT International Application No. PCT/KR2020/012885, which was filed on Sep. 23, 2020, and claims priority to Korean Patent Application No. 10-2019-0119831, filed on Sep. 27, 2019, in the Korean Intellectual Property Office, the disclosures of which are incorporated by reference herein their entirety.

### TECHNICAL FIELD

Certain embodiments of the disclosure relate to a method and an apparatus for executing an application.

### DESCRIPTION OF RELATED ART

Generally, when first executing an application, a process is executed in which data for a central processing unit (CPU) is loaded from auxiliary memory, such as a hard disk drive (HDD) into a faster memory, such as random-access memory (RAM) and/or a cache. Instructions included in the memory are executed, and eventually, an initial display screen for the corresponding executed app appears on a display.

When the application is first executed, the input/output (I/O) states of the application are not preloaded in memory (e.g., neither auxiliary storage nor main or rapid-access storage), and thus, there may be a delay in the initial launch of the application. Furthermore, if the application is re-launched, at least one of the I/O states may be preloaded via a list of I/O states loaded from previous executions, and overall loading time for an application may be reduced.

### SUMMARY

During an initial launch of a particular application (e.g., a video game), loading of the particular application may include loading an I/O state of the application to memory, which may require considerable time before loading is complete.

According to certain embodiments of the disclosure, the electronic device may generate a prediction of an application to be executed, based on a usage history of the electronic device and status information of the electronic device. Accordingly, at least some of the loading processes of the predicted application in an invisible state may be pre-executed. Because certain aspects of the loading process are pre-executed, the application may complete loading more quickly when it is actually selected for execution.

According to certain embodiments, an electronic device includes a display, a wireless communication unit, a processor operatively connected to the wireless communication unit, and a memory operatively connected to the processor. Programming instructions stored in the memory, when executed, cause the processor to: identify at least one application for which execution is predicted, based on a usage history of the electronic device and a state of the electronic device, execute a first loading procedure for the identified at least one application based on detecting satisfaction of a trigger condition related to the identified at least one application, after executing the first loading procedure, detect occurrence of an event related to the identified at least one application, execute a second loading procedure for the identified at least one application in response to detecting the occurrence of the event, and based on completion of the second loading procedure, display an execution screen of the identified at least one application via the display.

According to certain embodiments, a method may include: identifying, via a processor, at least one application for which execution is predicted, based on a usage history of the electronic device and a state of the electronic device, executing a first loading procedure based on detecting satisfaction of a trigger condition related to the identified at least one application, after executing the first loading procedure, detecting occurrence of an event related the identified at least one application, executing a second loading procedure for the identified at least one application in response to detecting the occurrence of the event, and based on completion of the second loading procedure, displaying an execution screen of the identified at least one application via a display.

The electronic device according to certain embodiments of the disclosure can predict an application to be executed based on the usage history and the state of the electronic device, and can pre-execute at least some of execution processes of the at least one prediction application. According to certain embodiments of the disclosure, the electronic device can complete the execution of the at least one prediction application more quickly by pre-executing the at least some of the loading processes prior to a request to initiate the application. According to certain embodiments of the disclosure, user convenience can be improved. In addition, various effects being directly or indirectly grasped through this document can be provided.

### BRIEF DESCRIPTION OF THE DRAWINGS

FIG. 1 is a block diagram illustrating an example electronic device in a network environment according to certain embodiments.

FIG. 2 is a block diagram illustrating an example program according to certain embodiments.

FIG. 3 is a block diagram of an example processor according to certain embodiments of the disclosure.

FIG. 4 is a flowchart illustrating an example method for determining a prediction app and allocating the determined prediction app to a CPU according to certain embodiments of the disclosure.

FIG. 5 is a flowchart illustrating an example method for determining a prediction app and pre-loading the prediction app according to certain embodiments of the disclosure.

FIG. 6 is a diagram illustrating an example pre-loading process of an application in accordance with elements included in an electronic device according to certain embodiments of the disclosure.

FIG. 7 is a diagram illustrating an example process of activating and displaying a prediction app on a display in accordance with elements included in an electronic device according to certain embodiments of the disclosure.

FIG. 8A is a diagram illustrating an example screen displayed through a display and a screen generated through an invisible window according to certain embodiments of the disclosure.

FIG. 8B is a diagram illustrating an example screen on which a display is turned off and a prediction application executed in an invisible window according to certain embodiments of the disclosure.

FIG. 9 is a diagram illustrating an example user interface to determine a prediction app in accordance with a user configuration according to certain embodiments of the disclosure.

### DETAILED DESCRIPTION

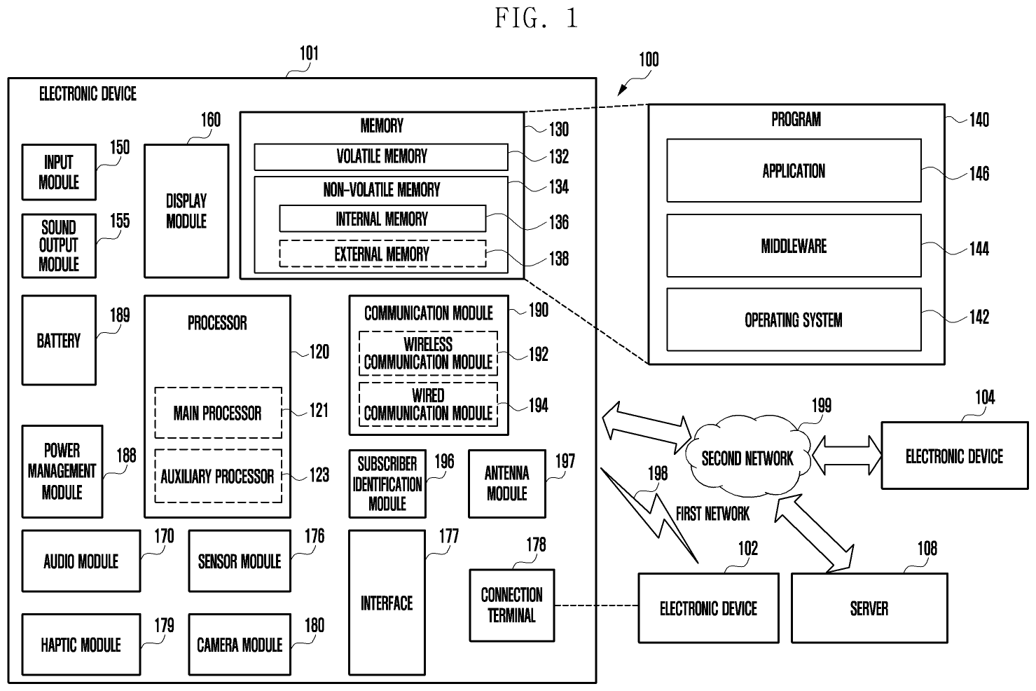

FIG. 1 is a block diagram illustrating an electronic device 101 in a network environment 100 according to certain embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. According to an embodiment, the wireless communication module 192 may identify and authenticate the electronic device 101 in a communication network, using subscriber information stored in the subscriber identification module 196.

The antenna module 197 may include at least one antenna for transmitting or receiving a signal or power to or from the outside. According to an embodiment, the communication module 190 (e.g., the wireless communication module 192) may transmit a signal to or receive a signal from an external electronic device through an antenna suitable for a communication scheme.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

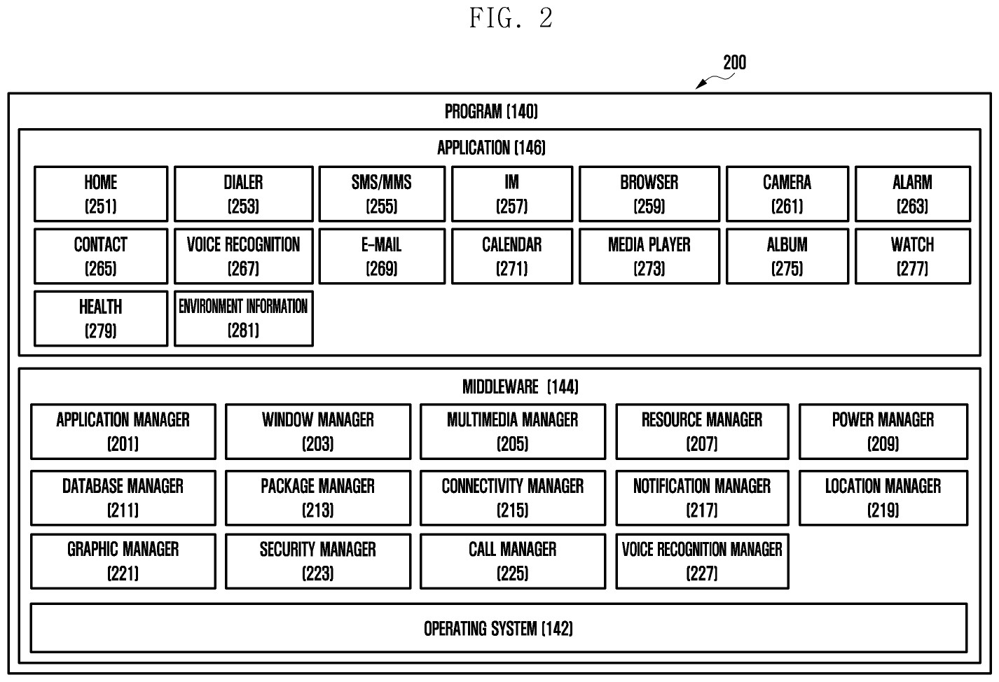

FIG. 2 is a block diagram 200 illustrating the program 140 according to certain embodiments. According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227. The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects. The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101. The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application running on the external electronic device.

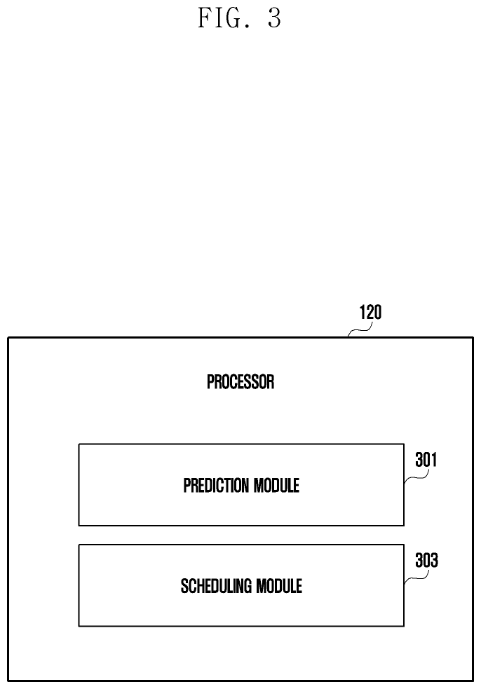

FIG. 3 is a block diagram of a processor according to certain embodiments of the disclosure.

With reference to FIG. 3, a processor (e.g., processor 120 of FIG. 1) of an electronic device (e.g., electronic device 101 of FIG. 1) may include a prediction module 301 for predicting an application to be executed and a scheduling module 303 for managing a program allocated to a memory (e.g., memory 130 of FIG. 1).

According to an embodiment, the prediction module 301 may predict an application (e.g., prediction app) to be executed next time based on a usage history for the electronic device 101 and state information of the electronic device 101. For example, the prediction module 301 may identify the usage history for the electronic device 101, and may predict at least one application to be executed next time based on the identified usage history. For example, the usage history may include time, place, usage frequency, and/or usage pattern. The usage history may include an application being used a lot by time zones, an application being used a lot based on locations of the electronic device 101, and/or a second application being used a lot after execution of a first application. According to another embodiment, the usage history may include execution information for an application being used a lot by a user based on an external environment and/or usage environment of the electronic device 101.

According to an embodiment, the prediction module 301 may predict the application to be executed next time based on the state information for the electronic device 101. For example, the state information may include information on whether to execute a WIFI function, whether to execute a Bluetooth (BT) function, and/or whether to execute a global positioning system (GPS) function. The state information may include information related to an activated function in the electronic device 101. According to an embodiment, the prediction module 301 may predict that a gallery application is to be used after a camera application is used in the electronic device 101 based on the usage history and the state information of the electronic device 101, and may determine the gallery application as the prediction app. According to an embodiment, the prediction module 301 may identify the first application being currently executed (activated), and may predict the second application (e.g., prediction app) to be executed after the execution of the first application.

According to an embodiment, the prediction app may include at least one application that is likely to be executed in the current electronic device 101. The prediction app may include at least one application to be executed next time in the electronic device 101. According to an embodiment, the electronic device 101 may determine at least one prediction app based on at least one of information about a current time, a current place, and/or a currently activated application.

According to an embodiment, the prediction module 310 may configure an algorithm (e.g., machine learning algorithm) based on the usage history and the state information of the electronic device 101, and may determine the prediction app through the configured algorithm. According to an embodiment, the algorithm may be updated based on the usage history and the state information of the electronic device 101 at a predetermine time.

According to an embodiment, the prediction module 301 may determine the prediction app based on the state information of the electronic device 101 (e.g., whether to turn on/off a WIFI function, whether to turn on/off a Bluetooth (BT) function, and/or whether to turn on/off a GPS function) and/or posture information (e.g., a screen rotation state, a stand state, a grip state, and/or whether a display (e.g., display device 160 of FIG. 1) is exposed to an outside).

According to an embodiment, the prediction module 301 may identify whether a trigger condition for determining the prediction app is satisfied, and if the trigger condition is satisfied, the prediction module 301 may determine the prediction app based on the usage history and the state information of the electronic device 101.

According to an embodiment, the prediction module 301 may execute the determined prediction app in an invisible mode. For example, the invisible mode may be a mode in which an application execution process is not displayed on the screen, and the application is preloaded in a background. According to an embodiment, the prediction module 301 may configure at least one thread related to the prediction app as a specific group (e.g., background group).

According to an embodiment, the scheduling module 303 may allocated at least one thread related to the prediction app to at least one of a high-performance core and/or a low-performance core. For example, the processor 120 may include the high-performance core having a relatively high processing speed and the low-performance core having a relatively low processing speed. The low-performance core may include a low-power core having low power consumption. The scheduling mode 303 according to an embodiment may identify a probability for a user to actually perform execution in relation to the prediction app, and may determine a priority based on the identified probability. If the priority of the prediction app is higher than a predetermined threshold value, the scheduling module 303 may allocate the prediction app to the low-performance core. The scheduling module 303 may execute the prediction app having the high priority while not degrading the basic performance of the electronic device 101. The scheduling module 303 according to an embodiment may execute the prediction app by allocating the prediction app to at least one of the high-performance core and/or the low-performance core so that a current efficiency of the processor 120 is optimized based on the group to which the prediction app is configured and the priority of the prediction app.

According to an embodiment, the processor 120 may share information on the first application being currently executed and information on the second application (e.g., prediction app) to be executed in relation to the first application with other electronic devices (e.g., electronic devices 102 and 104 and server 108 of FIG. 1). For example, the electronic device 101 may interlock with another electronic device through a network (e.g., first network 198 or second network 199 of FIG. 1). According to an embodiment, the processor 120 may synchronize information related to the prediction app through the server 108, and may obtain the information related to the prediction app synchronized by another electronic device. According to an embodiment, the processor 120 may determine the prediction app scheduled to be executed based on the information synchronized by another electronic device.

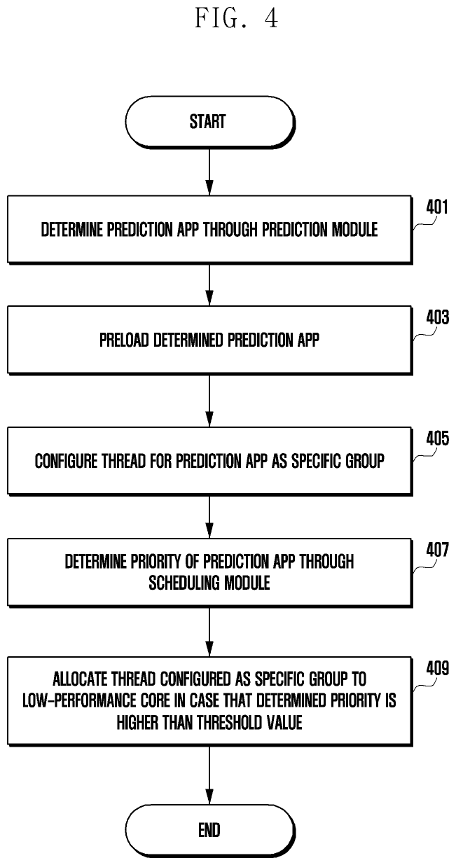

FIG. 4 is a flowchart illustrating a method for identifying an app for which execution is predicted (i.e., the “prediction app”), and allocating the prediction app to a CPU according to certain embodiments of the disclosure.

With reference to FIG. 4, at operation 401, a processor (e.g., processor 120 of FIG. 1) of an electronic device (e.g., electronic device 101 of FIG. 1) may identify a prediction app through a prediction module (e.g., prediction module 301 of FIG. 3). For example, the prediction app may be identified based on detecting a threshold feasibility that it will be executed, based on a usage history of the electronic device, and state information of the electronic device. According to an embodiment, the prediction module 301 may analyze the usage history and the state information of the electronic device 101, and may determine at least one prediction app based on the analyzed usage history. For example, the processor 120 may identify at least one application that is frequently used in association with a current time and/or a current place. The processor 120 may determine the at least one prediction app based on the at least one identified application. For example, the processor 120 may identify at least one application as likely to be executed, and set the application as the prediction app based at least on the current time and the current location.

At operation 403, the processor 120 may preload the identified prediction app. According to an embodiment, preloading may include pre-performing some of a plurality of execution and/or loading processes related to the application, prior to actual execution of the application. Since some portion of loading is completed prior to execution, the later execution of the preloaded application may be completed more quickly.

At operation 405, the processor 120 may configure a thread for the prediction app, within a specific grouping of application. For example, the prediction app may be treated as included within a background group of applications. According to an embodiment, the processor 120 may allocate the processing thread (as configured for the specific group) to at least one of a high-performance core and/or a low-performance core.

At operation 407, the processor 120 may determine a priority of the prediction app through a scheduling module (e.g., scheduling module 303 of FIG. 3). For example, the priority of the prediction app may be determined based on a probability that the prediction app is to be executed at a future time by the electronic device 101. For example, as the execution probability of the prediction app becomes higher, the priority of the prediction app may elevate. According to an embodiment, the processor 120 may identify the probability that the prediction app is to be executed based on the usage history and the state information of the electronic device 101, and may determine the priority for the prediction app in response to the identified probability.

At operation 409, if a current priority value of the prediction app is higher than a predetermined threshold value, the processor 120 may allocate the processing thread to the low-performance core. According to an embodiment, the processor 120 may allocate the prediction app having at least a threshold priority and a threshold probability of impending execution to the low-performance core, and the processor 120 may execute the prediction app (e.g., via preloading and/or background execution).

According to an embodiment, the processor 120 may determine the prediction app based on the usage history and the state information of the current electronic device, determine the priority for the determined prediction app, and allocate the thread for the prediction app to at least one of the high-performance core or the low-performance core in accordance with the determined priority. According to an embodiment, in executing the prediction app, the electronic device 101 may allocate the prediction app to the high-performance core and the low-performance core, and the function of the electronic device 101 may be utilized more efficiently. According to an embodiment, the processor 120 may allocate the prediction app having high priority to the low-performance core to execute the prediction app. According to an embodiment, the processor 120 may execute the prediction app having the high priority while not degrading the basic performance of the electronic device 101. According to an embodiment, since the processor 120 utilizes the low-performance core, the current efficiency of the electronic device 101 can be maximized, and less power can be used. According to an embodiment, as the performance of the electronic device 101 is improved, user convenience can be improved.

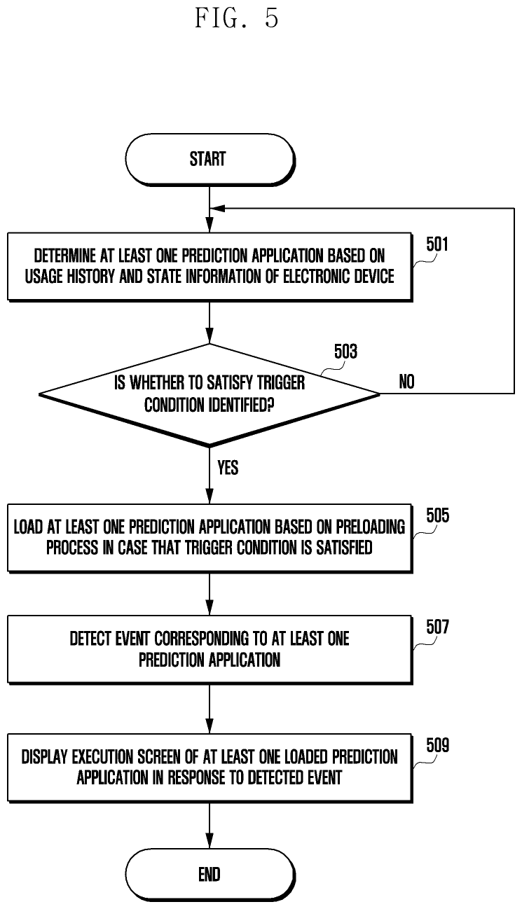

FIG. 5 is a flowchart illustrating a method for determining a prediction app and pre-loading the prediction app according to certain embodiments of the disclosure.

With reference to FIG. 5, at operation 501, a processor (e.g., processor 120 of FIG. 1) of an electronic device (e.g., electronic device 101 of FIG. 1) may determine at least one application (e.g., prediction app) based on a usage history and state information of the current electronic device 101. For example, the usage history may include information related to the usage of the electronic device 101 (e.g., usage information divided by time zones, usage information in accordance with places, usage frequency, and information related to a usage pattern) for a predetermine time. The state information may include information related to turn-on/off of a specific function of the electronic device 101 (e.g., whether to turn on/off a WIFI function, whether to turn on/off a Bluetooth (BT) function, and/or whether to turn on/off a global positioning system (GPS) function). For example, the prediction app may include at least one application to be executed next time in the current electronic device 101. According to an embodiment, the processor 120 may determine at least one prediction app based on the usage history and the state information of the electronic device 101. According to another embodiment, the processor 120 may interlock with another electronic device (e.g., server) through a network, and may obtain information related to the prediction app from another electronic device. The processor 120 may determine at least one prediction app based on prediction app related information obtained from another electronic device.

At operation 503, the processor 120 may identify whether a trigger condition is satisfied (e.g., has occurred). For example, the trigger condition may include an execution condition for initiating a preloading process for at least one application. For example, the preloading process may be a process of preferentially executing at least one of a plurality of loading processes for a specific application. According to an embodiment, when a specific application is first executed, at least one loading process may be performed, and at a time when the at least one loading process is completed in totality, the execution of the specific application may be completed. According to an embodiment, through the preloading process, the processor 120 may pre-execute the at least one loading process, and thus an execution time of the specific application may be reduced.

According to an embodiment, the trigger condition may include a condition that a display (e.g., display device 160 of FIG. 1) of the electronic device 101 is deactivated, a condition that the electronic device 101 has entered a sleep mode (e.g., low-power mode), an activation condition of a Wi-Fi function, an activation condition of a BT function, and/or an activation condition of a GPS function.

If the trigger condition is satisfied at operation 503, the processor 120, at operation 505, may load the at least one application based on the preloading process. For example, the preloading process may be an operation of pre-performing at least some of a plurality of processes being performed until the execution of the application is completed. According to an embodiment, the processor 120 may preload the at least one application (e.g., prediction app) in response to the satisfaction of the trigger condition.

According to an embodiment, the preloading process may include preloading the at least one application in a background state, without displaying an execution screen for the application on the display 160, in accordance with the execution process of the at least one application. According to an embodiment, the processor 120 may invisibly perform the preloading process for the at least one application.

If the trigger condition is not satisfied at operation 503, the processor 1230 may return to the operation 501, and may redetermine at least one application for which execution is predicted, based on the usage history and the state information of the electronic device 101.

At operation 507, the processor 120 may detect an event corresponding to the at least one application. For example, the event may include a user input for requesting execution of the at least one application. The event may include an event requesting display of the preloaded the at least one application via the display 160.

At operation 509, the processor 120 may display an execution screen for the at least one loaded application via the display 160, in response to the detected event. According to an embodiment, the at least one application may be in a state of having performed the preloading process at operation 505. According to an embodiment, the processor 120 may load the at least one application based on remaining processes excluding the process corresponding to the preloading process among all processes related to the execution of the at least one application. According to an embodiment, if loading of the at least one application is completed, the processor 120 may display the execution screen of the at least one application through the display 160.

According to certain embodiments, an electronic device (e.g., electronic device 101 of FIG. 1) may include a display (e.g., display device 160 of FIG. 1), a wireless communication unit (e.g., communication module 190 of FIG. 1), a processor (e.g., processor 120 of FIG. 1) operatively connected to the wireless communication unit 190, and a memory (e.g., memory 130 of FIG. 1) operatively connected to the processor 120. The memory 130, when executed, may cause the processor 120 to: determine at least one prediction application based on information on a usage history of the electronic device 101 and state information of the electronic device 101, execute the at least one prediction application based on a first execution procedure in case that a trigger condition related to the at least one prediction application is satisfied, detect an occurrence of an event for the at least one prediction application, execute the at least one prediction application based on a second execution procedure in response to the detection of the occurrence of the event, and display an execution screen of the at least one prediction application through the display 160.

According to an embodiment, the information on the usage history of the electronic device 101 may include information related to a usage time, a usage place, a usage frequency, and/or a usage pattern of the electronic device 101 for a predetermined period.

According to an embodiment, the state information of the electronic device 101 may include information related to activated functions in the electronic device 101 including whether to execute a WI-FI function, whether to execute a BT function, and/or whether to execute a GPS function.

According to an embodiment, the processor 120 may determine a priority for an application stored in the memory 130 based on the information on the usage history of the electronic device 101 and the state information of the electronic device 101, and may determine the at least one prediction application based on the determined priority.

According to an embodiment, the processor 120 may allocate the at least one prediction application to a low-performance core in case that the determined priority exceeds a predetermined threshold value, and may execute the at least one prediction application.

According to an embodiment, the trigger condition may include at least one of an on/off condition of the display 160, an entry condition of a low-power mode, an activation condition of a WI-FI function, an activation condition of a BT function, and/or an activation condition of a GPS function.

According to an embodiment, the first execution procedure may include a pre-loading process, and the processor 120 may load the at least one prediction application in a background state.

According to an embodiment, the preloading process may pre-perform at least one loading process for the at least one prediction application.

According to an embodiment, the second execution procedure may perform at least one loading process for the at least one prediction application by using a launcher.

According to an embodiment, the processor 120 may display the at least one determined prediction application as a list through the display 160, and may add or delete the at least one prediction application based on a user configuration.

According to certain embodiments, an application execution method may include: determining at least one prediction application based on information on a usage history of an electronic device (e.g., electronic device 101 of FIG. 1) and state information of the electronic device 101; executing the at least one prediction application based on a first execution procedure in case that a trigger condition related to the at least one prediction application is satisfied; detecting an occurrence of an event for the at least one prediction application; executing the at least one prediction application based on a second execution procedure in response to the detection of the occurrence of the event; and displaying an execution screen of the at least one prediction application on a display (e.g., display device 160 of FIG. 1).

According to an embodiment, the information on the usage history of the electronic device 101 may include information related to a usage time, a usage place, a usage frequency, and/or a usage pattern of the electronic device 101 for a predetermine period.

According to an embodiment, the state information of the electronic device 101 may include information related to activated functions in the electronic device 101 including whether to execute a WI-FI function, whether to execute a BT function, and/or whether to execute a GPS function.

According to an embodiment, determining the at least one prediction application may include determining a priority for an application stored in the memory (e.g., memory 130 of FIG. 1) based on the information on the usage history of the electronic device 101 and the state information of the electronic device 101, and determining the at least one prediction application based on the determined priority.

According to an embodiment, the at least one prediction application may be allocated to a low-performance core in case that the determined priority exceeds a predetermined threshold value, and the at least one prediction application may be executed.

According to an embodiment, the trigger condition may include at least one of an ON/OFF condition of the display 160, an entry condition of a low-power mode, an activation condition of a WI-FI function, an activation condition of a BT function, and/or an activation condition of a GPS function.

According to an embodiment, the first execution procedure may include a pre-loading process, and executing based on the first execution procedure may include loading the at least one prediction application in a background state.

According to an embodiment, the preloading process may pre-perform at least one loading process for the at least one prediction application.

According to an embodiment, the second execution procedure may perform at least one loading process for the at least one prediction application by using a launcher.

According to an embodiment, the method may further include displaying the at least one determined prediction application as a list through the display 160, and adding or deleting the at least one prediction application based on a user configuration.

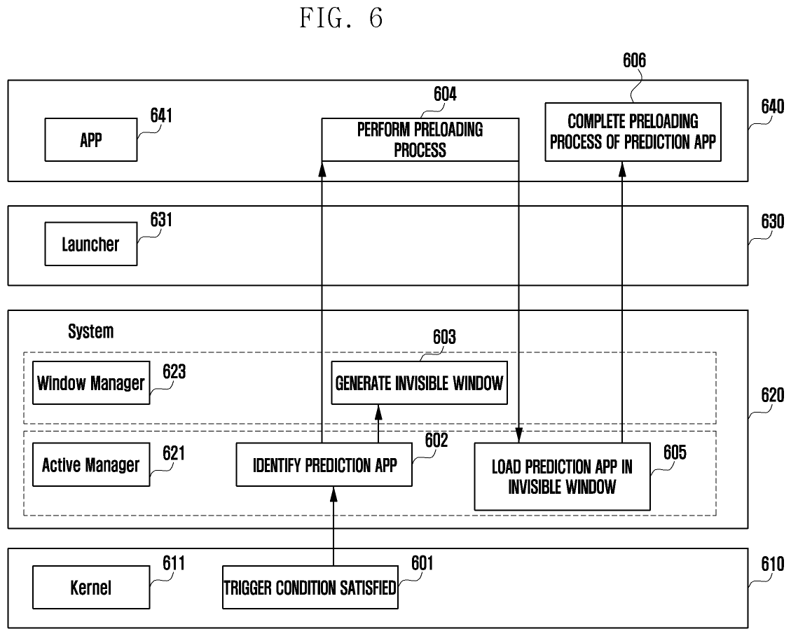

FIG. 6 is a diagram illustrating a pre-loading process of an application in accordance with elements included in an electronic device according to certain embodiments of the disclosure.

With reference to FIG. 6, a processor (e.g., processor 120 of FIG. 1) of an electronic device (e.g., electronic device 101 of FIG. 1) may preload an application via a preloading process performed by at least four computing elements (e.g., kernel 611, system 620, launcher 631, and/or application (app) 641). For example, the preloading process may preferentially execute at least one of a plurality of loading processes for a specific application. FIG. 6 illustrates a process in which the preloading process is divided into four operations 610, 620, 630, and 640 to be performed under the control of four computing elements (e.g., kernel 611, system 620, launcher 631, and/or application 641), but the preloading process is not limited thereto, and other variations are contemplated.

With reference to FIG. 6, the processor 120 may be in a state in which an application (e.g., prediction app) has been identified as likely for impending execution, based on the usage history for the electronic device 101 and the state information of the electronic device 101.

At operation 601, the kernel 611 may identify whether a trigger condition corresponding to the prediction app is satisfied. For example, the trigger condition may include an execution condition controlling initiation of a preloading process for the prediction app. According to an embodiment, the trigger condition may include, for example, deactivation of a display (e.g., display device 160 of FIG. 1) of the electronic device 101, entering into a sleep mode (e.g., low-power mode), activation of a WI-FI function, activation of a BT function, and/or activation of a GPS function. According to an embodiment, the trigger condition may include the execution condition of the preloading process for the prediction app.

At operation 602, an active manager 621 included in the system 620 may identify the prediction app corresponding to the detected trigger condition. According to an embodiment, the system 620 may perform a process by the active manager 621 and a window manager 623. For example, the active manager 621 may activate at least one application, or may perform some operations of the at least one application in accordance with the execution process. The active manager 621 may manage the execution process for the at least one application. The window manager 623 may manage a window being displayed through the display device 160 of the electronic device 101. For example, the window manager may generate an invisible window in relation to the application executed in the background, and may perform a (pre)loading process of the application in the background so as not to be displayed on the display device 160.

At operation 603, the window manager 623 may generate an invisible window that is not displayed via the display device 160. For example, the window manager 623 may execute the at least one application at least partly based on the generated invisible window. According to an embodiment, the window manager 623 may manage a window that is displayed through the display device 160, and the invisible window that is not displayed through the display device 160 like an application being executed in the background.

According to an embodiment, an app 641 may include at least one application. At operation 604, the at least one application may perform the preloading process under the control of the system 620.

At operation 605, the active manager 621 of the system 620 may initiate preloading the prediction app identified at operation 602 in the invisible window. The invisible window may include a virtual window that is not displayed through the display device 160. According to an embodiment, like an application executed as a background process, the active manager 621 may preload the prediction app within the invisible window that is not displayed on the screen.

At operation 606, the app 641 may complete the preloading of the prediction app. The preloading process may be a procedure of preferentially executing at least some of a plurality of execution processes for the prediction app. According to an embodiment, if an execution event for the prediction app is detected in a state where the preloading process for the prediction app is completed, the processor 120 may provide the prediction app to a user more rapidly, as compared to executing a load of the prediction app without any preloading. According to an embodiment, since the preloading process among the execution processes related to the prediction app is in a preloaded state, the processor 120 may provide the prediction app to the user in less time.

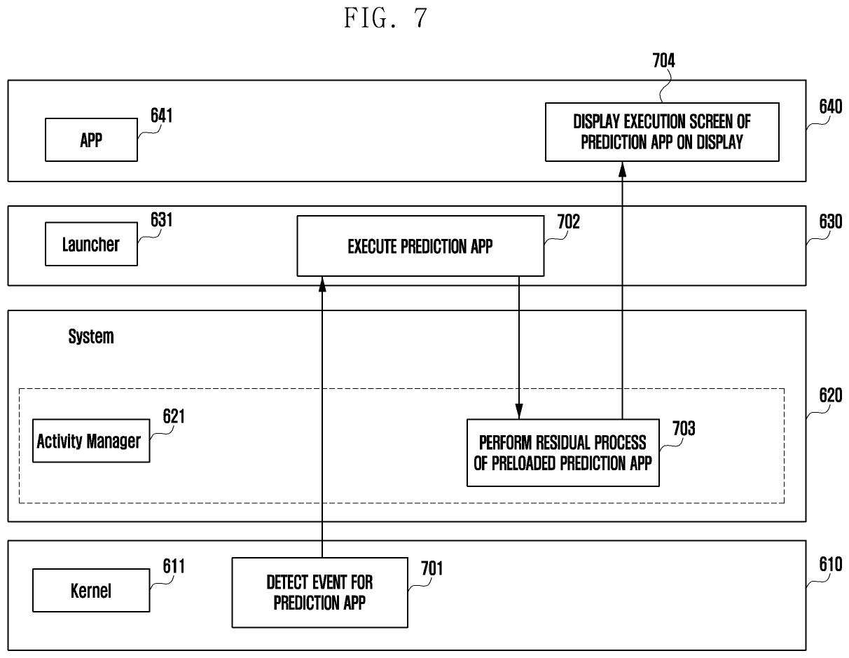

FIG. 7 is a diagram illustrating a process of activating and displaying a prediction app on a display in accordance with elements included in an electronic device according to certain embodiments of the disclosure.

With reference to FIG. 7, a processor (e.g., processor 120 of FIG. 1) of an electronic device (e.g., electronic device 101 of FIG. 1) may display, through a display (e.g., display device 160 of FIG. 1), a prediction app preloaded by four elements (e.g., kernel 611, system 620, launcher 631, and/or application (app) 641). FIG. 7 illustrates a process of displaying, on the display 160, the prediction app, which is divided into four operations 610, 620, 630, and 640 and is preloaded, under the control of four elements (e.g., kernel 611, system 620, launcher 631, and/or application 641), but the display process is not limited thereto.

With reference to FIG. 7, the processor 120 may determine the prediction app based on the usage history for the electronic device 101 and the state information of the electronic device 101, and may be in a state that a preloading process for the determined prediction app has been performed.

At operation 701, the kernel 611 may detect an event for the prediction app. For example, the event may include an event related to the execution of the prediction app. According to an embodiment, the processor 120 may detect a user input has requested execution of the prediction app.

At operation 702, the launcher 631 may initiate the execution of the prediction app. For example, in response to the occurrence of the event for the prediction app, the launcher 631 may initiate the execution of the prediction app to cause the prediction app to be displayed through the display 160.

At operation 703, an active manager 621 included in the system 620 may perform any remaining unperformed loading processes for the preloaded prediction app. For example, in case of executing a specific application, the processor 120 may perform at least one execution process for the specific application as a whole. According to an embodiment, in case of the prediction app, the preloading process may have been completed, and the processor 120 may complete any remaining loading processes (e.g., excluding the completed preloading processes) from among a totality of the execution/loading processes for executing the application. According to an embodiment, in case of the prediction app, since the preloading process has already been performed, the execution of the execution processes can be completed as a whole through performing of the residual processes.

At operation 704, the app 641 may display an execution screen for the prediction app through the display 160. According to an embodiment, since the prediction app has completed preloading, the processor 120 can rapidly execute the application and display the execution screen of the prediction app through the display 160. For example, in a state where the execution of all the execution processes for the application has been completed, the execution screen may include an image for the application.

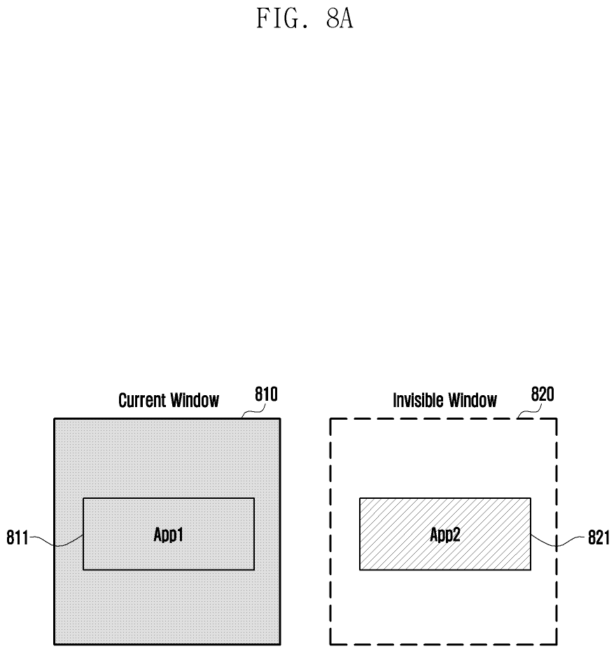

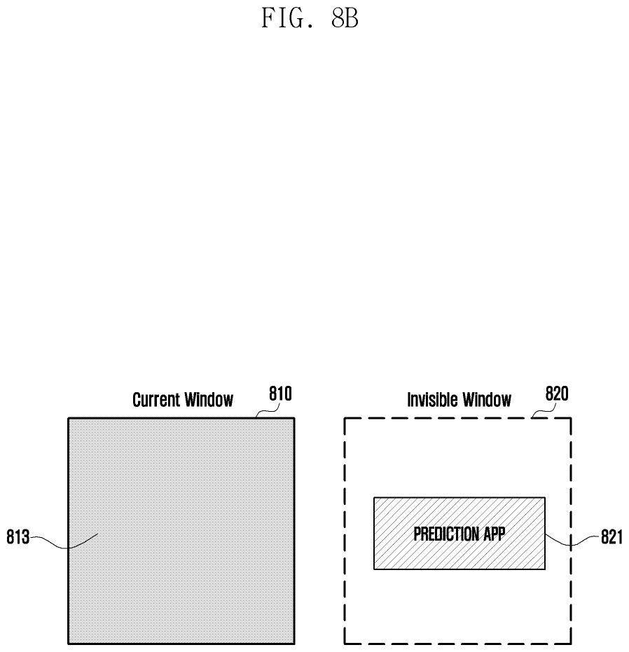

FIGS. 8A and 8B are diagrams illustrating a screen displayed through a display and a screen generated through an invisible window according to certain embodiments of the disclosure.

With reference to FIG. 8A, an electronic device (e.g., electronic device 101 of FIG. 1) may display a current screen 810 through a display (e.g., display device 160 of FIG. 1). For example, the current screen 810 may include an execution image for a first application (app1) 811. According to an embodiment, a processor (e.g., processor 120 of FIG. 1) of the electronic device 101 may identify a usage history and state information of the electronic device 101 in a state where an execution screen for the first application 811 has been displayed. The processor 120 may determine a second application 821 to be executed after the execution of the first application 811 based on the usage history and the state information of the electronic device 101 (e.g., as a prediction app). For example, the processor 120 may identify the usage history and the state information for the electronic device, and may determine the second application 821 having a threshold likelihood of being impending execution, after the execution of the first application 811 based on the identified usage history and state information. For example, in case that the first application 811 is a camera application, the second application 821 may be determined to be a gallery application. According to an embodiment, a plurality of second applications 821 may be provided. The number of second applications 821 may be determined depending on the processing ability of the electronic device 101.

According to an embodiment, the processor 120 may generate an invisible window for preloading an application, and may perform a preloading process for a determined second application 821. The invisible window may include a virtual window that is not displayed through the display 160. According to an embodiment, if an event for display of the second application 821 is detected, the processor 120 may display the generated invisible window through the display 160.

With reference to FIG. 8B, an electronic device 101 may display a current screen 810 through a display 160. For example, the current screen 810 may be in a state where the display 160 is deactivated. According to an embodiment, a processor (e.g., processor 120 of FIG. 1) of the electronic device 101 may identify a usage history and state information of the electronic device 101 at a time when the display 160 is switched from an off state to an on state. For example, the processor 120 may determine at least one application (e.g., prediction app 821) being frequently used after a user turns on the screen of the electronic device 101.

According to an embodiment, the processor 120 may generate an invisible window for preloading the prediction app 821, and may perform a preloading process for the determined prediction app 821. The invisible window may include a virtual window that is not displayed through the display 160. According to an embodiment, the processor 120 may generate an invisible window for the prediction app 821 in case that a trigger condition for the preloading process is satisfied even in a state where the display 160 is turned off. If an event for the prediction app 821 is detected, the processor 120 may display the generated invisible window through the display 160. For example, the event for the prediction app 821 may include a detection event for a user input for executing the prediction app 821.

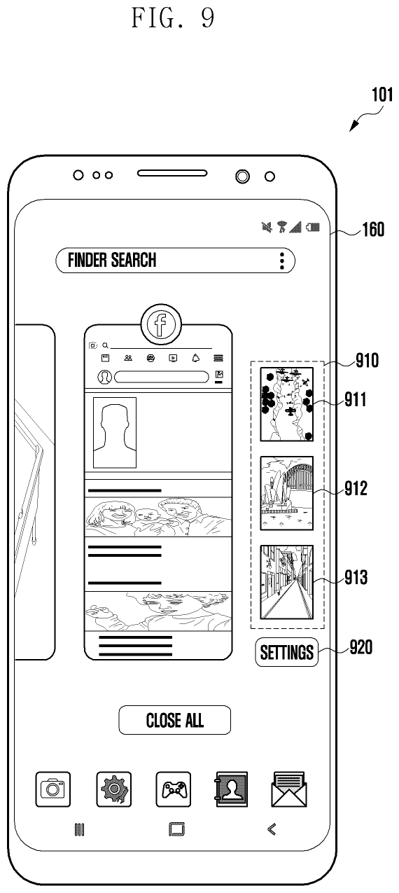

FIG. 9 is a diagram illustrating a user interface to determine a prediction app in accordance with a user configuration according to certain embodiments of the disclosure.

With reference to FIG. 9, a display (e.g., display device 160 of FIG. 1) of an electronic device (e.g., electronic device 101 of FIG. 1) is illustrated. When the display 160 is in an activated state, the electronic device 101 may display a user interface (UI) including at least one application that was recently used. For example, in the illustrated example, a Facebook application was recently active, and so the electronic device 101 may display an execution screen of the Facebook application at least partly through a user interface. According to an embodiment, the electronic device 101 may display icons corresponding to prediction apps 911, 912, and 913 within a partial area 910 of the user interface. For example, the selection of prediction apps 911, 912, and 913 may be updated based on the at least one application (e.g., Facebook application) that was recently executed. According to an embodiment, preloading for all of the prediction apps 911, 912, and 913 may be completed. According to an embodiment, the electronic device 101 may have identified the prediction apps 911, 912, and 913 based on a usage history and state information of the electronic device 101.

According to an embodiment, one or more of the present prediction apps 911, 912, and 913 may be changed and updated, in accordance with a user configuration. For example, the user interface may include a configuration icon 920 for changing at least one of the prediction apps 911, 912, and 913. The electronic device 101 may detect a selection of the configuration icon 920, receive a user's input changing configuration settings for identifying the prediction apps, and subsequently change one or more of the displayed prediction apps 911, 912, and 913 according to the user's new configuration that was entered. According to an embodiment, the prediction apps 911, 912, and 913 may include applications which are frequently utilized by the user.

According to an embodiment, the electronic device 101 may display the user interface for changing the at least one prediction app 911, 912, and 913, and may change the at least one prediction app 911, 912, and 913 in accordance with a user input.

According to an embodiment, if a predetermined time elapses, the electronic device 101 may release at least one prediction app, and may identifying another prediction app based on the usage history and the state information of the electronic device 101 at the current time.

According to an embodiment, in a situation in which a new application is installed, the electronic device 101 may identify and display the new application as one of the prediction apps.

Embodiments of the disclosure that are disclosed in the specification and drawings are merely for easy explanation of the technical contents of the embodiments of the disclosure and proposal of specific examples to help understanding of embodiments of the disclosure, but are not intended to limit the disclosure. Accordingly, it should be construed that all changes or modifications derived based on the technical concept of the certain embodiments of the disclosure are included in the embodiments of the disclosure in addition to the embodiments disclosed herein.

What is claimed is:

1. An electronic device, comprising:
a display;
a wireless communication unit;
a memory; and
a processor operatively connected to the memory and the wireless communication unit; and wherein the memory stores instructions that are executable by the processor to cause the electronic device to:
identify at least one application for which execution is predicted, based on a usage history of the electronic device and a state of the electronic device,
execute a first loading procedure for the identified at least one application based on detecting satisfaction of a trigger condition related to the identified at least one application,
after executing the first loading procedure, detect occurrence of an event related to the identified at least one application,
execute a second loading procedure for the identified at least one application in response to detecting the occurrence of the event, and
based on completion of the second loading procedure, display an execution screen of the identified at least one application via the display.

2. The electronic device of claim 1, wherein the usage history of the electronic device includes at least one of a usage time, a usage location, a usage frequency, and/or a usage pattern of the electronic device, as recorded for a predetermined period of time.

3. The electronic device of claim 1, wherein the state of the electronic device includes at least one of a state of a Wi-Fi function, a state of a Bluetooth (BT) function, and a state of a global positioning satellite (GPS) locating function.

4. The electronic device of claim 1, wherein the processor is configured to:
determine a priority for an application stored in the memory, based on at least the usage history of the electronic device and the state of the electronic device,
wherein the at least one application for which execution is predicted is identified based at least in part on the determined priority.

5. The electronic device of claim 4, wherein the processor includes a plurality of processing cores, and
wherein the processor is configured to:
based on determining that the determined priority exceeds a threshold priority value, allocate the identified at least one application to a lower-performance core of the processor.

6. The electronic device of claim 1, wherein the trigger condition includes at least one of activation of the display, entry into a low-power mode, activation of a Wi-Fi function, and activation of a GPS function.

7. The electronic device of claim 1, wherein the first loading procedure includes pre-performing at least one loading process for the identified at least one application.

8. The electronic device of 7, wherein pre-performing the at least one loading process is executed in a background state by the processor.

9. The electronic device of 1, wherein the second loading procedure includes executing a loading process for the identified at least one application using a launcher.

10. The electronic device of 1, wherein the processor is configured to:
display a list for the identified at least one application via the display, and
add the identified at least one application to the list, or delete the identified at least one application from the list based on a user configuration.

11. A method in an electronic device, comprising:
identifying, via a processor, at least one application for which execution is predicted, based on a usage history of the electronic device and a state of the electronic device;
executing a first loading procedure based on detecting satisfaction of a trigger condition related to the identified at least one application;
after executing the first loading procedure, detecting occurrence of an event related the identified at least one application;
executing a second loading procedure for the identified at least one application in response to detecting the occurrence of the event; and
based on completion of the second loading procedure, displaying an execution screen of the identified at least one application via a display.

12. The method of claim 11, wherein the usage history of the electronic device includes at least one of a usage time, a usage location, a usage frequency, and/or a usage pattern of the electronic device, as recorded for a predetermined period of time.

13. The method of claim 11, wherein the state of the electronic device includes at least one of a state of a Wi-Fi function, a state of a Bluetooth (BT) function, and a state of a global positioning satellite (GPS) locating function.

14. The method of claim 11, further comprising:
determining a priority for an application stored in the memory, based on at least the usage history of the electronic device and the state of the electronic device,
wherein the at least one application for which execution is predicted is identified based at least in part on the determined priority.

15. The method of claim 14, based on determining that the determined priority exceeds a threshold priority value, allocate the identified at least one application to a lower-performance core included in the processor.

16. The method of claim 11, wherein the trigger condition includes at least one of activation of the display, entry into a low-power mode, activation of a Wi-Fi function, and activation of a GPS function.

17. The method of claim 11, wherein the first loading procedure includes pre-performing at least one loading process for the identified at least one application.

18. The method of claim 17, wherein pre-performing the at least one loading process is executed in a background state by the processor.

19. The method of claim 11, wherein the second loading procedure includes executing a loading process for the identified at least one application using a launcher.

20. The method of claim 11, further comprising:
displaying a list for the identified at least one application via the display; and
adding the identified at least one application to the list, or deleting the identified at least one application from the list based on a user configuration.
